(19) United States
(12) Patent Application Publication
(10) Pub. No.: US 2013/0019737 A1
(43) Pub. Date: Jan. 24, 2013

(54) SYSTEM AND METHOD FOR MUSIC INSTRUCTION ON PIANO

(71) Applicant: Robert Smith, Terrel, TX (US)

(72) Inventor: Robert Smith, Terrel, TX (US)

(21) Appl. No.: 13/186,636

(22) Filed: Jul. 20, 2011

(51) Int. Cl. G09B 15/02

(52) U.S. Cl. 84/483.2

(57) ABSTRACT

The present disclosure relates to s music instruction method. A system is provided which allows a user to more intuitively understand and play music without the complexity of traditional piano learning and embodies comprises a step-by-step instruction method of basic chords. The system also streamlines composition and arrangement of piano music for the beginner. The invention further provided which allows a learner to more intuitively understand basic music theory and performance.

### CROSS-REFERENCE TO RELATED APPLICATIONS

### TECHNICAL FIELD

This invention relates to a method for music education, and, in particular to a method of teaching and playing the piano.

### REFERENCES TO BE CITED

### U.S. Patent Documents

| | | |
|---|---|---|
| Lemons; Apr. 26, 2011 | System and Method | U.S. Pat. No. 7,932,454 |
| | of Music Instruction | |
| Miller; Apr. 5, 2011 | Music Training | U.S. Pat. No. 7,919,705 |
| | System | |
| Winther; Sep. 7, 2010 | Easy-keys | U.S. Pat. No. 7,790,973 |
| Harrison, Apr. 19, 2005 | Relative Chord | U.S. Pat. No. 6,881,883 |
| | Keyboard | |
| | Instructional | |
| | Method | |

Applicant references the above patents for inclusion in the examiner's analysis of the system and method presented herein.

### BACKGROUND OF THE INVENTION

The method of teaching and practicing music vary from the most basic of instructions to the most complex, with each teaching and practicing method becoming progressively more complex. The complexity of the piano has often frustrated most beginners, and most lose interested given this complexity. It is true that training by constant repetition has been passed down virtually unchanged from ancient times, through many generations, and is the basic training method used today. The present training methods are design to bring one through beginning up to concert quality playing. Such present training inapposite of the present invention in that the present invention can rapidly teach basic play in a few direct steps. The present invention strives not to achieve concert quality playing, but rather to end the frustration of the beginners so that they too many enjoy a lifetime of playing the piano in a manner to replicate a sufficient plethora of musical compositions and arrangements.

Most piano training problems become progressively more intense the further one goes down the musical skill hierarchy. Piano students are most often taught how to play a musical instrument using songs and/or practice pieces, comprising notes on a staff that increase in difficulty or complexity as the student continues practicing. This traditional process requires significant practice and, as is most often stated, employs counterintuitive methods of traditional staff notation.

The present invention is intuitive, uncomplicated, and can quickly alleviate a learner's need of an instructor, and avoids the intensive training of more skilled musicians. Simply stated, with the present invention boredom is removed, extensive learning diminished, and true piano play of a sufficient quality is given to the beginning pianist in the shortest amount of time.

### SUMMARY

The present invention is a method for instruction in Piano. It consists of three basic concepts: the Basic 123 music method, the Melodic method, and the Special chords, more particularly described herein. The Basic 123 method comprises first, using your left hand, rest your index finger on the first note of the key you want to play the song in. See E♭ of FIG. 1. E♭ is called “1.” To find “2,” begin with “1,” and count up six half steps, or six white and black keys. That note is designated “2” and is A♭ in this embodiment. See A♭ of FIG. 1. A♭ is called “2.” From “2”, count up three more half steps for “3” which is B♭. See B♭ of FIG. 1. B♭ is called “3.” The 1, 2 and 3 key combinations form the initial key combinations in the present invention piano instruction method. No more than three (3) fingers per hand will be required by the learner at any given time to form the basic 1, 2, and 3 notes of E♭, A♭ and B♭. Therefore, when a learner is directed to play a “1” note, Eb is played with the learner's left hand; when a learner is directed to play a “2” note, the learner play's A♭ with the learner's left hand; and when a learner is directed to play a “3” note, the learner similarly plays B♭ with the learner's left hand. Many songs can be played on the piano with just these three 1, 2 and 3 notes. The present invention will teach the left hand first because it is the bass, which carries the melody of the song. The right hand is subsequently trained to play about two (2) chords. Thus, Basic 123 music method consists of 1, 2 and 3 played in the left hand; and the Melodic method of about (2) chords in the right hand. After the Basic 123 music method, and the Melodic method, are learned, certain song may require a Special chord to give the music a distinct flavor and sound.

The present music instruction method will have the following lessons on the music intended to be played:
Lesson 1 instructs on the Basic 123 bass of the music;
Lesson 2, the Melodic method, adds melody to the bass of the music;
Lesson 3 provides the Special chord required to add musical elements to complete the song; and
Lesson 4 instructs the learned about listening to chord and melodic changes in the song.

The present invention can teach you how to play a song customized to this present invention in about four music lessons, a significant advantage to defeat the boredom and repetition inherent in traditional piano instruction.

To find the right hand chords that accompany the left hand's Basic 1, 2, and 3, a learner must first find the same note that your left hand started with on 1 (E♭) and from there using the right hand, place your last finger (pinky) on the same piano note two octaves up. After that, place your right index finger five (5) half steps to the left. This will cause a learner's index finger will end up on B♭. The learned must then count down three (3) notes and the thumb should be placed on G key. This chord is called “1” in the Basic method. See FIG. 1 and FIG. 7. With the pinky finger still on the first key (E♭), move your right index finger over to the right two notes to C key. Then move the thumb, over to the right one note to A♭. Move your left index finger seven half steps down to A♭. This chord is “2” in the Basic method. See FIG. 1 and FIG. 8. In the Basic method, chords 2 and 3 have the same notes on the right hand, but with A♭ and B♭ respectively on the left hand. Therefore, in the 2 position, move your left index finger up two half steps to B♭ to find “3.” See FIG. 1 and FIG. 9.

All chords are only played with at most three fingers (thumb, index, and pinky) on the right hand. This is called “missing fingers.” The present invention enforces the non-use of the missing fingers, which simplifies the present inventive instruction method thereby enhancing the efficiency by which songs are learned and played. The Basic 123 music method and the Melodic chords can be quickly referenced a shown (left hand/right hand possibilities):
1=E♭/(G,B♭,E♭) See FIG. 1 and FIG. 7

2=/(A♭,C,E♭) See FIG. 1 and FIG. 8

3=B♭/(A♭,C,E♭) See FIG. 1 and FIG. 9

While playing a song, when the learner is instructed to play a “1”, the left hand plays E♭ while the right hand plays chords selected from the group consisting of G, B♭, and E♭ with the thumb, index, and pinky finger, respectively. When a learned is instructed to play a “2”, the left hand plays A♭ and the right hand plays chords selected from the group consisting of A♭, C, and E♭, as applicable. When a learner is instructed to play a “3”, the left hand plays B♭ and the right hand plays chords selected from the group consisting of A♭, C, and E♭, as applicable.

When a music lesson calls for a chord with a bass note that is not in the Basic 123, that note is called a melodic note, which is used to form melodic chords. Melodic notes are found in the scale between 1 and 2. For example, in the key of E♭, E♭ is 1 then melodic notes are selected from the group consisting of notes F, G, and C. In order to make a melodic chord with bass note F, for example, a learner would play F with the left hand and chord 2 with the right hand. See FIG. 2 and FIG. 10. This is called F/2 (Left/Right). Furthermore, melodic chords can also be formed by combining two basic chords together. For example, playing the bass note from 3 with the basic chord in 1 is called 3/1.
Melodic Chords
F/2=F/(A♭,C,E♭) See FIG. 2 and FIG. 10
G/1=G/(G,B♭,E♭) See FIG. 2 and FIG. 11
C/1=C/(G,B♭,E♭) See FIG. 2 and FIG. 12
3/1=B♭/(G,B♭,E♭) See FIG. 2 and FIG. 13

In songs, this method of notation is used to simplify what you on a sheet of music. FIG. 4, FIG. 5, and FIG. 6 are examples of musical compositions utilizing the present invention. Less congestion of notes, letters, and space makes it easier to see and react to the music. For example, you might see “1−F/2−G/1” to express moving from chord 1 to F/2 and then to G/1.

While the invention has been described with respect to particular illustrated embodiment, those skilled in the art and technology to which the invention pertains will have no difficulty devising variations which in no way depart from the invention. Accordingly, the present invention is not limited to the specific embodiments described above, but rather as defined by the scope of the appended claims and their equivalents.

### BRIEF DESCRIPTION OF THE DRAWINGS

For a more complete understanding, attached are drawings which show the system and method in various configurations.

FIG. 1 Basic 123 Chords in Key of Eb

FIG. 2 Melodic Chords in Key of Eb

FIG. 3 Assorted Chords in Key of Eb

FIG. 4 Down at the Cross Music Notation in Key of Eb

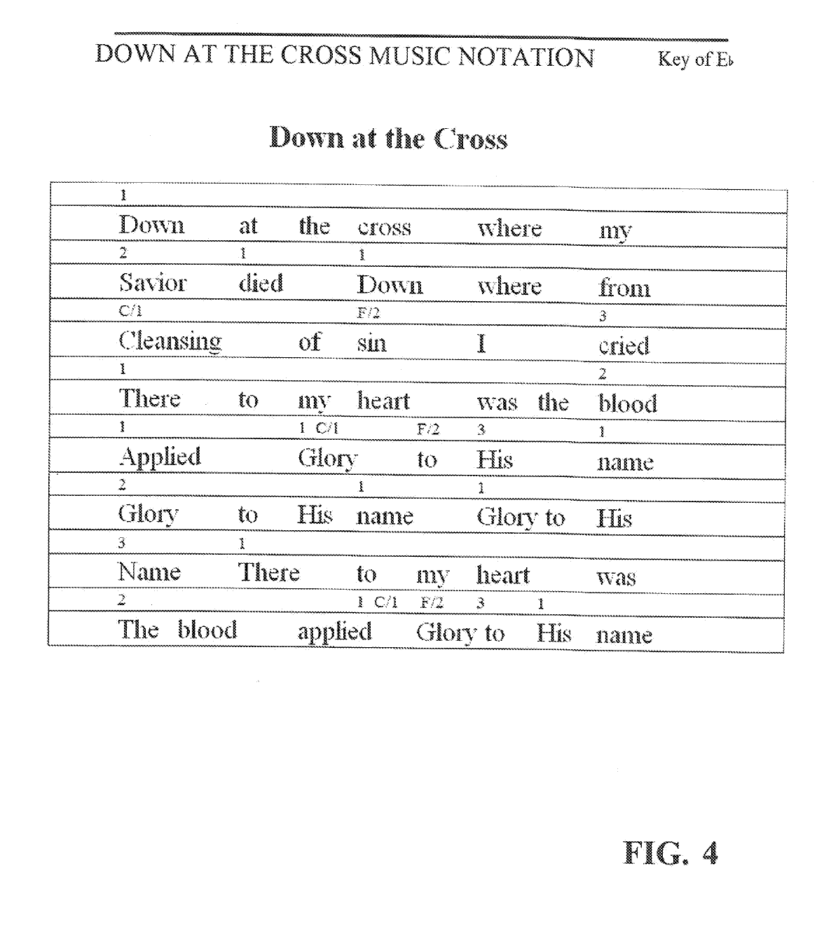

FIG. 5 At the Cross Music Notation in Key of Eb

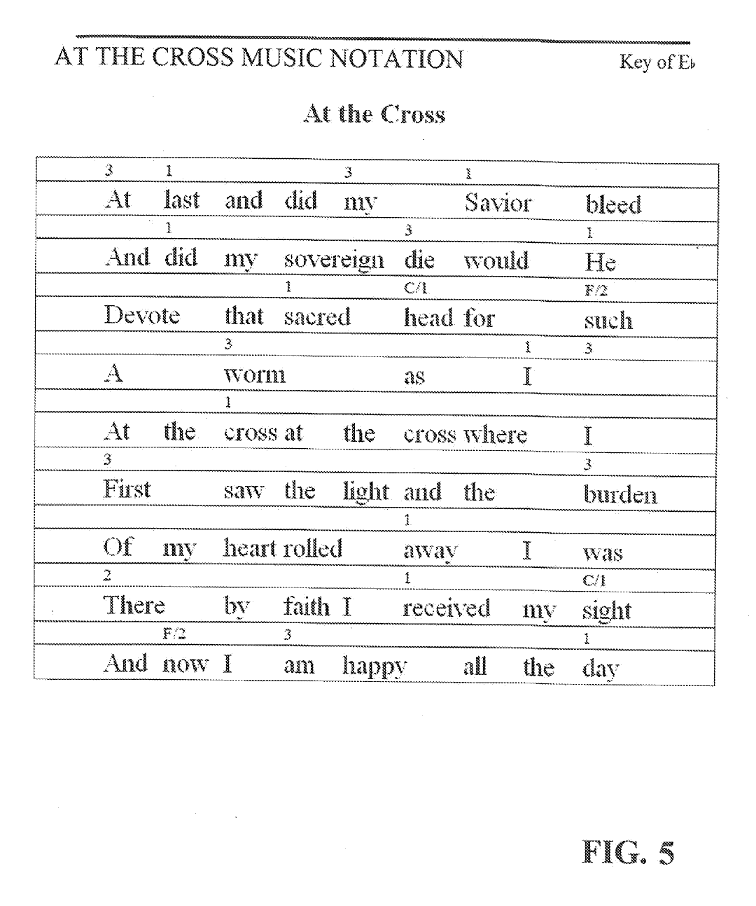

FIG. 6 O How 1 Love Jesus Music Notation in Key of Eb

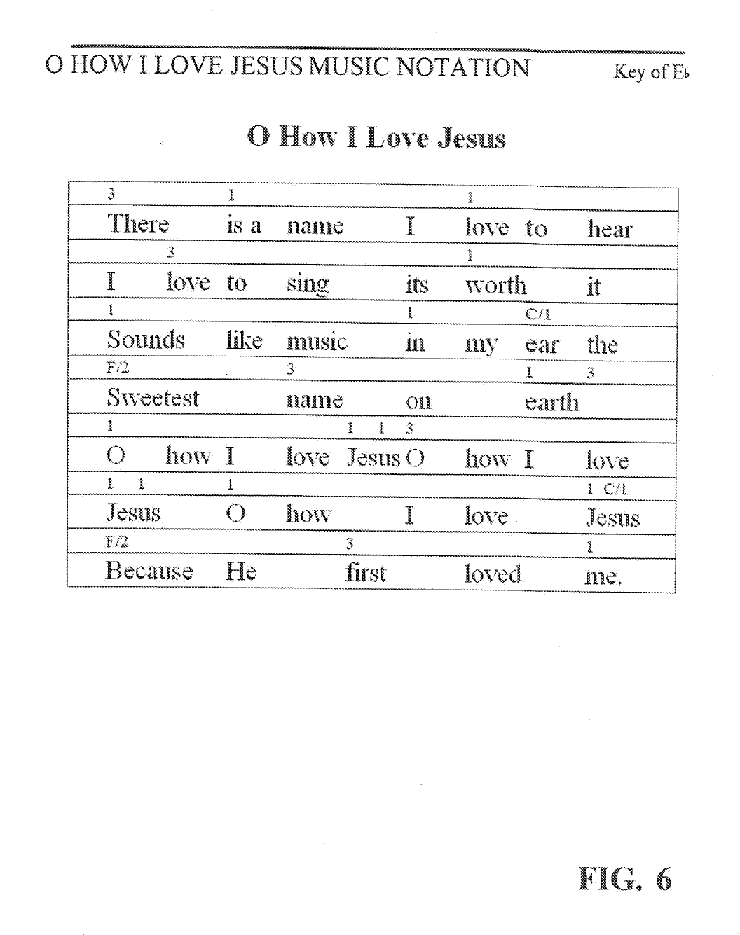

FIG. 7 Chord 1 Hand Positions in Key of Eb

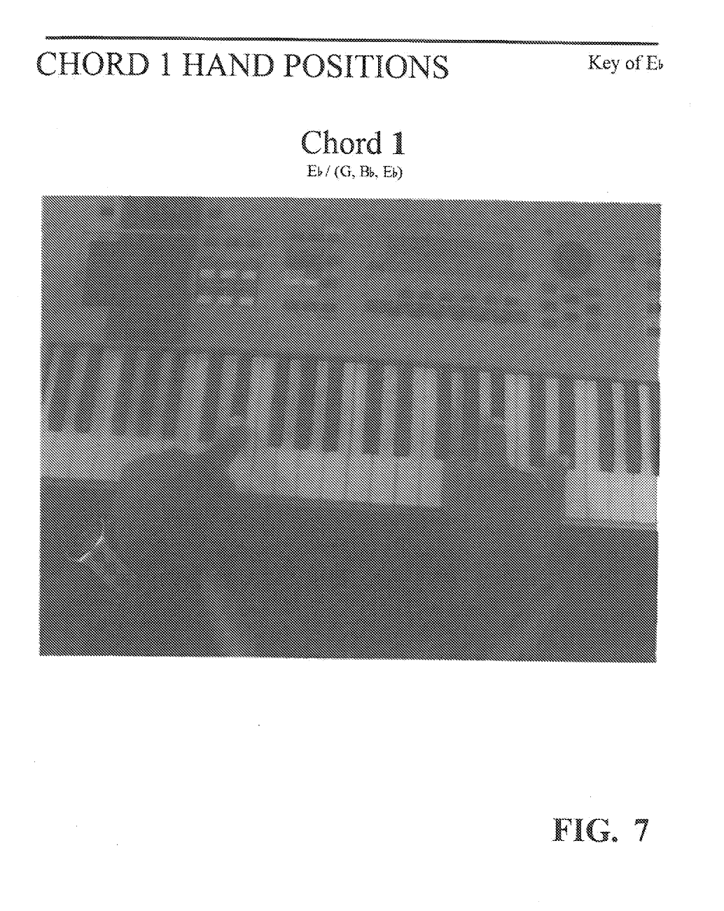

FIG. 8 Chord 2 Hand Positions in Key of Eb

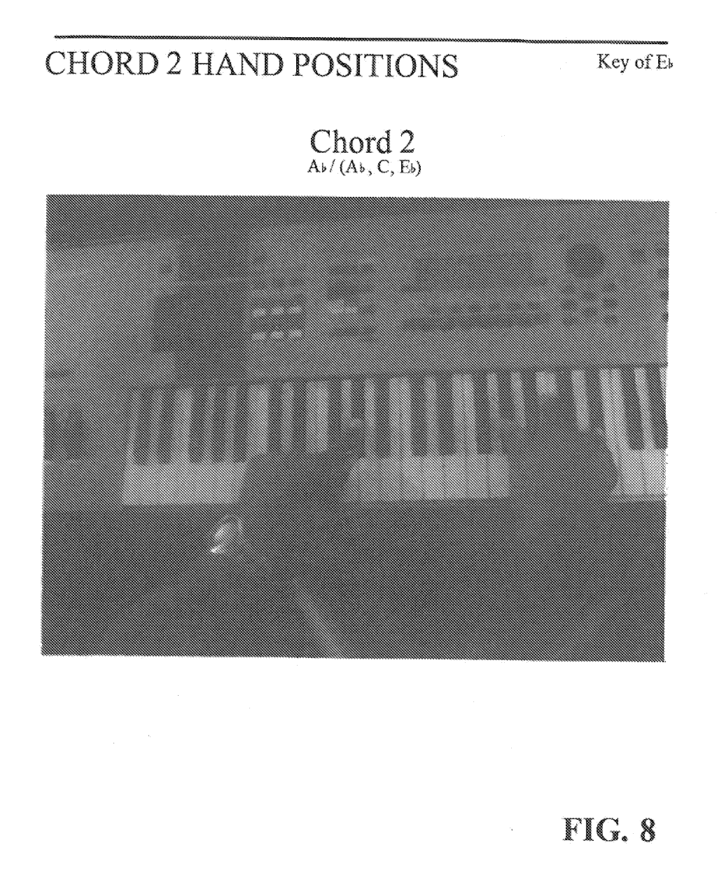

FIG. 9 Chord 3 Hand Positions in Key of Eb

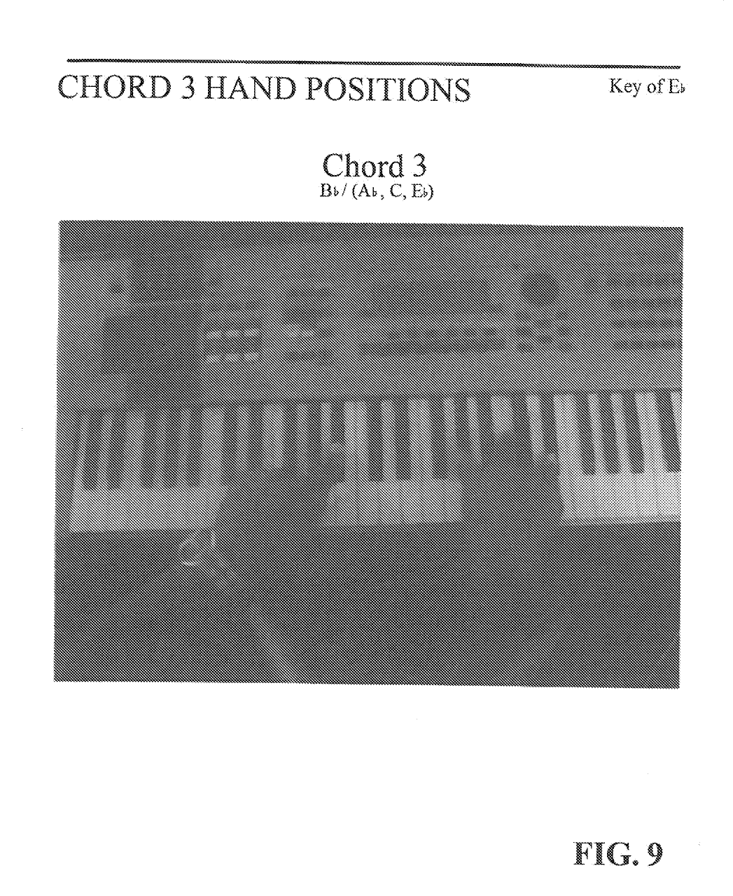

FIG. 10 Chord F/2 Hand Positions in Key of Eb

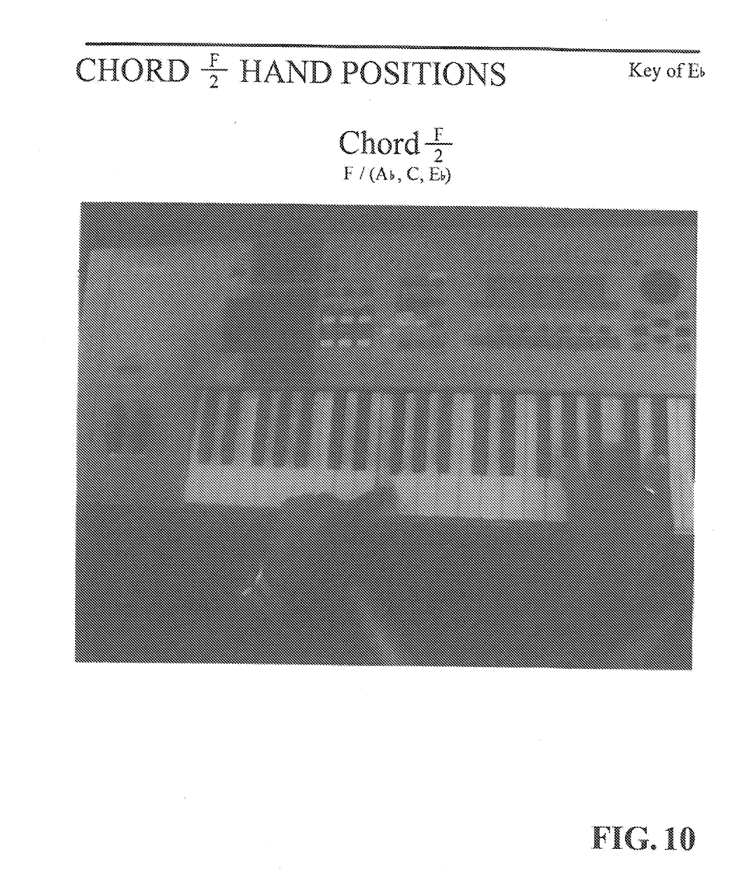

FIG. 11 Chord G/1 Hand Positions in Key of Eb

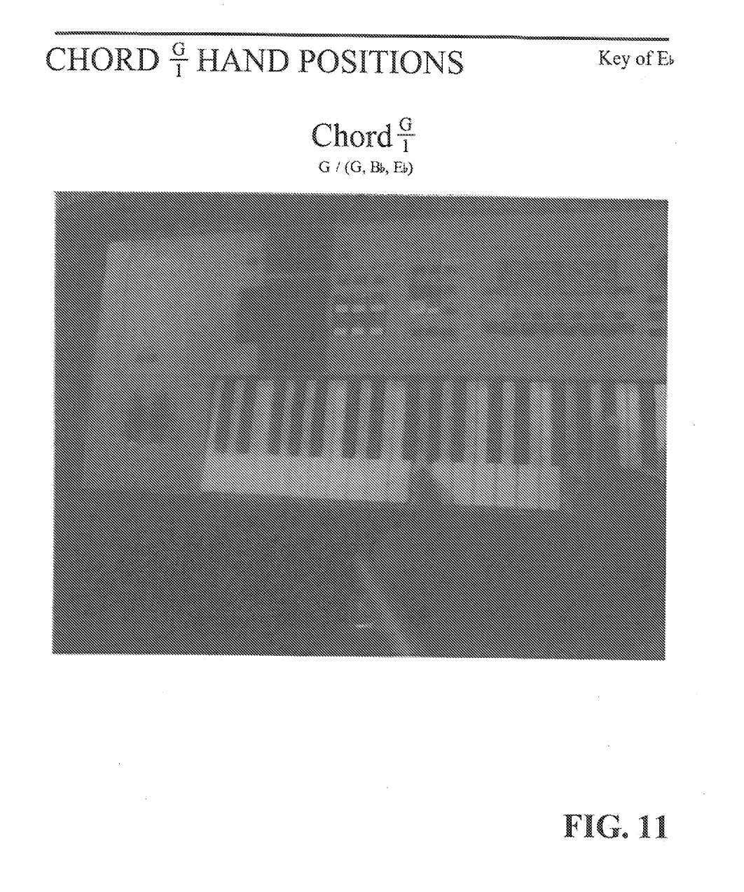

FIG. 12 Chord C/1 Hand Positions in Key of Eb

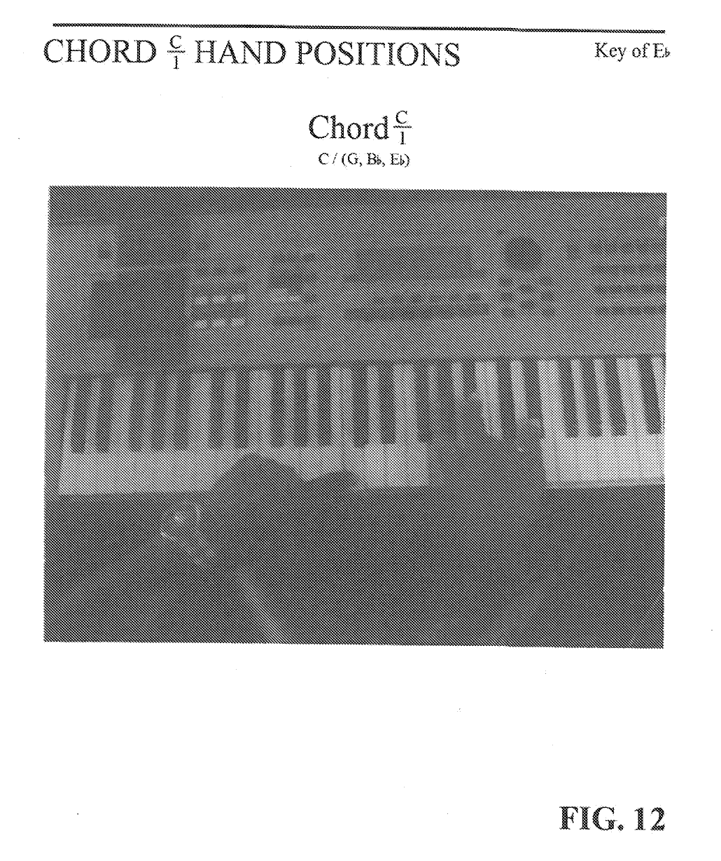

FIG. 13 Chord 3/1 Hand Positions in Key of Eb

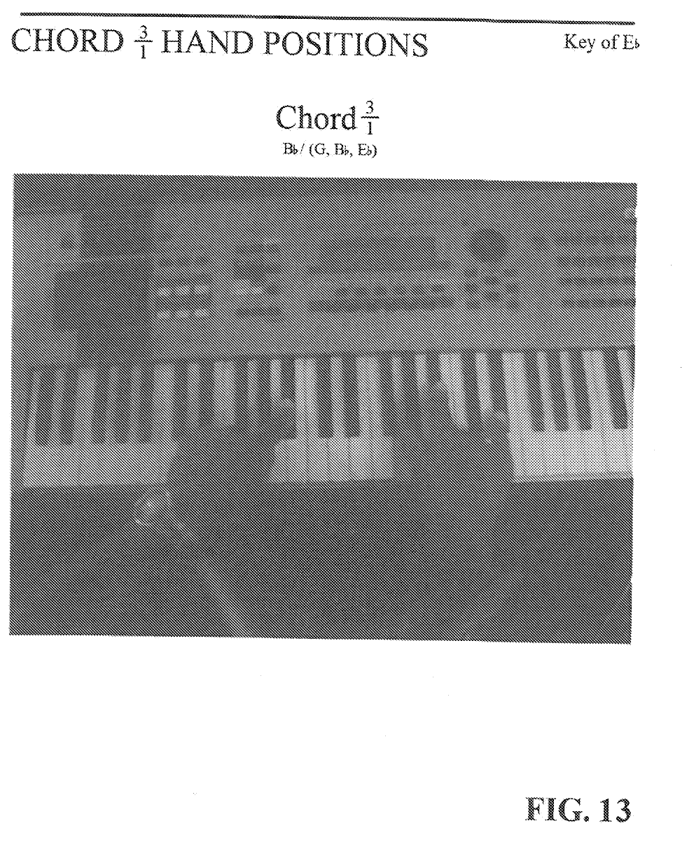

### DETAILED DESCRIPTION OF THE PREFERRED EMBODIMENTS

While the above description is of the preferred embodiment of the present invention, it should be appreciated that the invention may be modified, altered, or varied without deviating from the scope and fair meaning of the following claims.
Lesson 1 instructs on the Basic 123 bass of the music;
Lesson 2, the Melodic method, adds melody to the bass of the music;
Lesson 3 provides the Special chord required to add musical elements to complete the song; and
Lesson 4 instructs the learned about listening to chord and melodic changes in the song.
   Lessons 1, 3 and 3 can be used independently of Lesson 4.

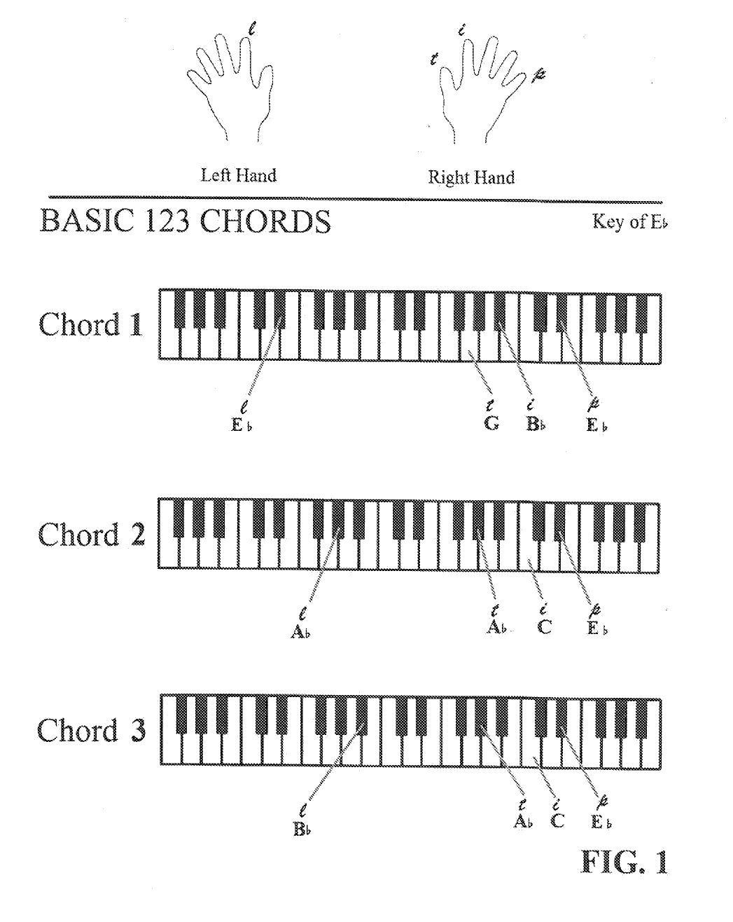

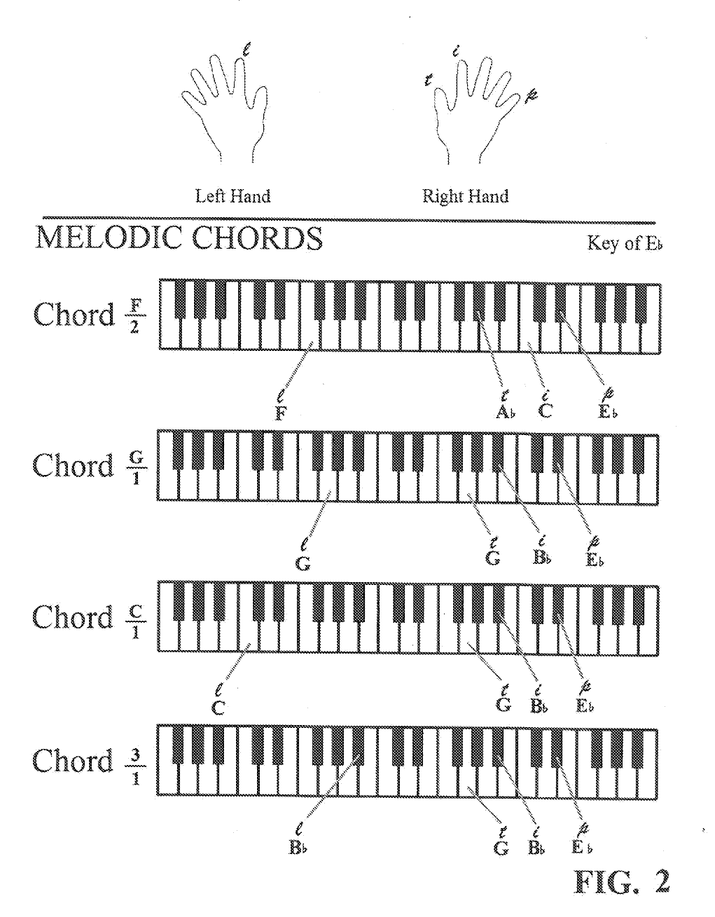

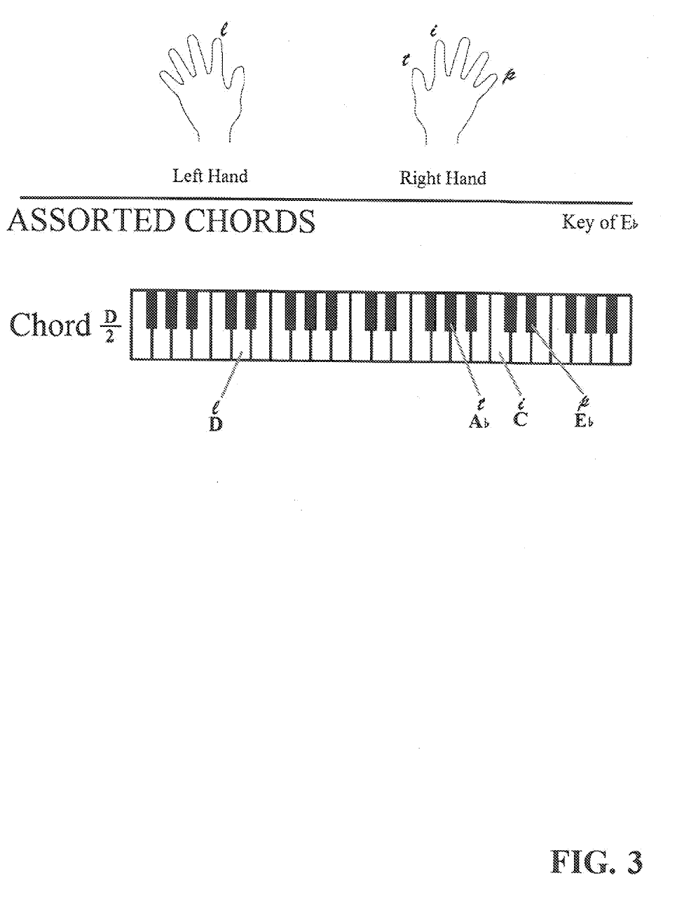

FIG. 1 shows the Basic 123 Chords in Key of Eb, FIG. 2 shows the Melodic Chords in Key of Eb and FIG. 3 shows the Assorted Chords in Key of Eb. These Basic 123 Chords, Melodic Chords, and Assorted Chords are readily interchangeable into another key. At least three (3) music lessons are required to instruct a piano player to utilize the present invention, optimally only three (3) lessons.

1. A method for teaching music on an instrument said method comprising: instructing an instrument player to successively play a musical composition on said instrument using at least one (1) finger from the left hand of said instrument player capable of playing a musical note, and one musical chord played from at least a plurality of three (3) fingers from the right hand or said instrument player, and providing a visual means for a musical note notation and a musical chord notation and thereby guiding said instrument player to successively play said musical composition.

2. The method of claim 1 wherein said step of providing a visual means comprises identifying on a tangible medium a notation system associated with said musical note, and said musical chord, and combining said musical note and said musical chord in a single visual means, and depicting said visual means immediately next to one another to be played as a sequence of said musical composition.

3. The method of claim 2 wherein said tangible medium is selected from the group consisting of computer display, videotape, and sheet music.

4. The method of claim 3 wherein said visual means is selected from the group consisting of numerical characters, alphabetical characters, and musical symbols.

5. The method of claim 4, wherein the instrument is a piano.

6. A method for teaching music on an instrument, said method comprising: instructing an instrument player to successively play a musical composition on the said instrument using at least three (3) music lessons, the first lesson comprising the Basic 123 bass of the music, the second lesson Basic 123 chords comprising the Melodic chord added to said Basic 123 bass of the music, and the third lesson comprising the Special chords required to add musical elements to complete said musical composition.

7. The method of claim 6, wherein said Basic 123 bass of the music is taught using one (1) finger from the left hand of said instrument player capable of playing a musical note.

8. The method of claim 7, wherein said Melodic chord method is taught using at least three (3) fingers from the right hand of said instrument player.

9. The method of claim 8, wherein said Basic 123 chords are taught using one (1) finger from the left hand playing at least one note from said Basic 123 bass and three (3) fingers from the right hand playing at least one chord from Melodic chords of said instrument player.

10. The method of claim 6, wherein the instrument is a piano.

11. (canceled)

12. (canceled)

13. (canceled)

14. (canceled)

15. (canceled)

16. The method claim 7, wherein Basic 123 bass comprising:
Basic 1, a note of a key on a tangible medium;
Basic 2, a note counted up by six half steps from said Basic 1; and
Basic 3, a note counted up by three half steps from said Basic 2.

17. The method claim 8, wherein Melodic comprising;
A two-octaves-up-note of a key on a tangible medium;
Other notes of keys in a tangible medium.
